(19) United States
(12) Patent Application Publication
(10) Pub. No.: US 2025/0142529 A1
(43) Pub. Date: May 1, 2025

(54) METHOD AND APPARATUS FOR PAGING SUBGROUP BASED PAGING IN WIRELESS COMMUNICATION SYSTEM

(71) Applicant: Samsung Electronics Co., Ltd., Suwon-si, Gyeonggi-do (KR)

(72) Inventor: Anil AGIWAL, Suwon-si (KR)

(21) Appl. No.: 18/694,114

(22) PCT Filed: Sep. 23, 2022
(86) PCT No.: PCT/KR2022/014234

§ 371 Date: Mar. 21, 2024

(30) Foreign Application Priority Data
Sep. 24, 2021 (KR) 10-2021-0126708

(51) Int. Cl. H04W 68/02

(52) U.S. Cl. CPC H04W 68/02

(57) ABSTRACT

The disclosure relates to a 5G or 6G communication system for supporting a higher data transmission rate. A method performed by a user equipment (UE) in a wireless communication system is provided. The method may include: receiving, from a base station, system information associated with a paging subgroup; identifying a value associated with a number of paging subgroups for a core network (CN) assigned subgrouping, based on the system information; and determining a paging subgroup identification (ID) associated with a UE ID based subgrouping, based on the identified value.

### TECHNICAL FIELD

The disclosure relates to wireless communication systems, and more particularly, to a method and an apparatus for a paging procedure based on paging subgroups in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

The disclosure relates to a method and an apparatus for a paging procedure based on paging subgroups in a wireless communication system.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a bitmap for paging subgroups in accordance with an embodiment of the disclosure;

FIG. 2 illustrates a bitmap for paging subgroups in accordance with an embodiment of the disclosure;

FIG. 3 illustrates a bitmap for paging subgroups in accordance with an embodiment of the disclosure;

FIG. 4 illustrates a bitmap for paging subgroups in accordance with an embodiment of the disclosure;

FIG. 5 illustrates a flow chart describing UE operation according to an embodiment of the disclosure;

FIG. 6 illustrates a flow chart describing UE operation according to an embodiment of the disclosure;

FIG. 7 is a diagram illustrating a UE according to an embodiment of the present disclosure; and

FIG. 8 is a diagram illustrating a base station according to an embodiment of the present disclosure.

### MODE FOR THE INVENTION

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in corre-spondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Hereinafter, for convenience of explanation, the disclosure uses terms and names defined in the 3rd generation partnership project long term evolution (3GPP LTE) standards. However, the disclosure is not limited to the terms and names, and may also be applied to systems following other standards.

In the disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a user equipment (UE), a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system supports standalone mode of operation as well dual connectivity (DC). In DC, a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising the primary cell. For a UE in RRC_CONNECTED configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; and Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR, search space configuration comprises parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x-Monitoring-offset-PDCCH-slot)mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the coreset associated with the search space. The search space configuration includes the identifier of coreset configuration associated with it. A list of coreset configurations are signaled by gNB for each configured BWP wherein each coreset configuration is uniquely identified by an identifier. Note that each radio frame is of 10 ms duration. Radio frame is identified by a radio frame number or system frame number. Each radio frame comprises several slots wherein the number of slots in a radio frame and duration of slots depends on subcarrier spacing. The number of slots in a radio frame and duration of slots depends radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is QCLed with SSB/CSI RS of TCI state) used by gNB for transmission of PDCCH in the PDCCH monitoring occasions of a search space.

In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

In the RRC_IDLE, a UE specific DRX may be configured by upper layers. The UE monitors short Messages transmitted with P-RNTI over DCI; monitors a Paging channel for CN paging using 5G-S-TMSI; performs neighboring cell measurements and cell (re-) selection; acquires system information and can send SI request (if configured); performs logging of available measurements together with location and time for logged measurement configured UEs.

In RRC_INACTIVE, a UE specific DRX may be configured by upper layers or by RRC layer; UE stores the UE Inactive AS context; a RAN-based notification area is configured by RRC layer. The UE monitors Short Messages transmitted with P-RNTI over DCI; monitors a Paging channel for CN paging using 5G-S-TMSI and RAN paging using full I-RNTI; performs neighbouring cell measurements and cell (re-) selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the 5^{th} generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. UE can monitor any PO in paging DRX cycle and monitors at least one PO in SI modification period. In the RRC idle/inactive mode UE monitors PO in its active DL BWP. A PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in cell. The UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicating the index of the PO is determined by i_s=floor (UE_ID/N) mod Ns.
T is DRX cycle of the UE.

In RRC_INACTIVE state, T is determined by the shortest of the UE specific DRX value configured by RRC, UE specific DRX value configured by NAS, and a default DRX value broadcast in system information.

In RRC_IDLE state, T is determined by the shortest of UE specific DRX value configured by NAS, and a default DRX value broadcast in system information. If UE specific DRX is not configured by upper layers (i.e. NAS), the default value is applied.
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAnd-PagingFrameOffset as defined in TS 38.331. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI as defined in clause 13 in TS 38.213. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)^{th} PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)th PO is a set of ‘S’ consecutive PDCCH monitoring occasions for paging starting from the PDCCH monitoring occasion number indicated by firstPDCCH-MonitoringOccasionOfPO (i.e. the (i_s+1)^{th} value of the firstPDCCH-MonitoringOccasionOfPO parameter). Otherwise, the (i_s+1)^{th} PO is a set of ‘S’ consecutive PDCCH monitoring occasions for paging starting from the (i_s*S)^{th} PDCCH monitoring occasion for paging. ‘S’ is the number of actual transmitted SSBs determined according to parameter ssb-PositionsInBurst signalled in SystemInformationBlockl received from gNB. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration.

The PDCCH addressed to P-RNTI carries information according to DCI format 1_0. The following information is transmitted by means of the DCI format 1_0 with CRC scrambled by P-RNTI:
Short Messages Indicator-2 bits according to Table 1.
Short Messages-8 bits according to Table 2. If only the scheduling information for Paging is carried, this bit field is reserved.

$$Frequency domain resource assignment - ⌈ {log}_{2} ( {N}_{RB}^{DL , BWP} ( {N}_{RB}^{DL , BWP} + 1 ) / 2 ) ⌉ bits .$$

If only the short message is carried, this bit field is reserved.
N_{RB}^{DL,BWP} is the size of CORESET 0
Time domain resource assignment-4 bits. If only the short message is carried, this bit field is reserved.
VRB-to-PRB mapping-1 bit. If only the short message is carried, this bit field is reserved.
Modulation and coding scheme-5 bits. If only the short message is carried, this bit field is reserved.
TB scaling-2 bits. If only the short message is carried, this bit field is reserved.
Reserved bits-6 bits

TABLE 1
Short Message indicator

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 defines Short Message. Bit 1 is the most significant bit.

TABLE 2
Short Message

| Bit | Short Message |
|---|---|
| 1 | systemInfoModification |
| | If set to 1: indication of a BCCH modification other than SIB6, SIB7 |
| | and SIB8. |
| 2 | etwsAndCmasIndication |
| | If set to 1: indication of an ETWS primary notification and/or an |
| | ETWS secondary notification and/or a CMAS notification. |
| 3-8 | Reserved |

Early paging indication is supported before the paging occasion. The early paging indication indicates paging for one or more paging subgroups. The UE can identify corresponding paging subgroup in one of the following ways:
CN (core network) assigned paging subgroup: Paging subgroup identity is assigned by the CN (i.e. by AMF using NAS message)
Paging subgroup determined based on UE ID: Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

The UE belongs to sub group ‘k’=└UE_ID/(N*Ns)┘ mod P, where
N is the number of Paging frames, Ns is the number of POs per paging frame and
P is the number of paging sub groups

Cell can support both CN assigned and UE ID based paging subgroups in order to support UEs with different capabilities. The paging subgroup assigned by the CN to the UE and the paging subgroup determined by the UE based on the UE ID can overlap resulting in false alarms amongst UEs supporting different subgrouping method. For example, the CN assigns paging subgroup identity 4 to UE 1, UE 2 which does not support the CN based subgrouping determines that its paging subgroup identity is 4 based on its UE_ID. If there is paging for the UE 1, the gNB indicates that there is paging for paging subgroup 4 in early paging indication. In this case even though there is no paging for the UE 2, the UE 2 will unnecessarily wake up and monitor paging occasion.

### Method 1

In one method of this disclosure, early paging indication (or paging DCI) includes separate bitmap for the CN assigned paging subgroups and the UE ID based paging subgroups. The bitmap for the CN assigned paging subgroups can be referred as CN-SubgroupingBitmap. The bitmap for the UE ID based paging subgroups can be referred as UEIDSubgroupingBitmap. Each bitmap can be of same or different length (i.e. number of bits in the bitmap). The length depends on the number of paging subgroups. If the maximum number of the CN assigned paging subgroups is ‘x’, the size of CNSubgroupingBitmap is ‘x’ bits. If the maximum number of the UE ID based paging subgroups is ‘y’, the size of UEIDSubgroupingBitmap is ‘y’ bits. ‘x’ and ‘y’ are integers. The maximum number of the UE ID based paging subgroups and the maximum number of the CN assigned paging subgroups can be same or different. The maximum number of the UE ID based paging subgroups and the maximum number of the CN assigned paging subgroups can be signaled in system information and/or in NAS message. If the maximum number of the UE ID based paging subgroups and the maximum number of the CN assigned paging subgroups are same, maximum number of paging subgroups can be signaled in system information and/or in NAS message.

Each bit in CNSubgroupingBitmap corresponds to a paging subgroup assigned by the CN (i.e. corresponds to CN assigned paging subgrouping identity). kth bit (from least significant bit or from most significant bit) in CNSubgroupingBitmap corresponds to the CN assigned paging subgroup with identity k. k is integer.

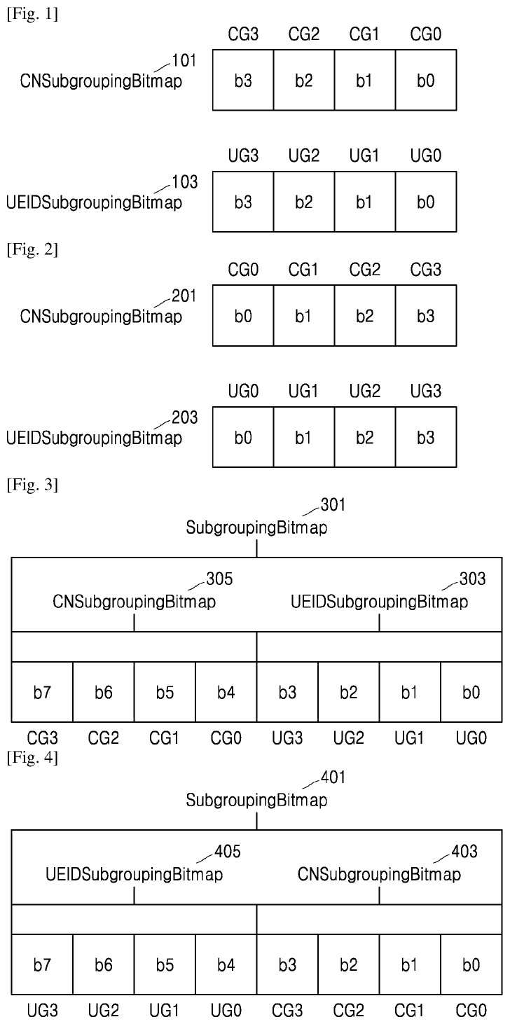

FIG. 1 and FIG. 2 illustrate a bitmap for paging subgroups according to an embodiment of the disclosure.

For example, if there are four CN assigned paging subgroup with identity 0, 1, 2 and 3, b0 corresponds to the CN assigned paging subgroup with identity 0, b1 corresponds to CN assigned paging subgroup with identity 1, b2 corresponds to CN assigned paging subgroup with identity 2, b3 corresponds to CN assigned paging subgroup with identity 3, where bits in CNSubgroupingBitmap are numbered from b0 to b3 starting from least significant bit (as shown in a bitmap (101) of FIG. 1) or are numbered from b0 to b3 starting from most significant bit (as shown in a bitmap (201) of FIG. 2).

Each bit in UEIDSubgroupingBitmap corresponds to a paging subgroup determined based on UE ID (i.e. corresponds to UE ID based paging subgrouping identity). kth bit (from least significant bit or from most significant bit) in UEIDSubgroupingBitmap corresponds to UE ID based paging subgroup with identity k. k is integer. For example, if there are four UE ID based paging subgroup with identity 0, 1, 2 and 3, b0 corresponds to the UE ID based paging subgroup with identity 0, b1 corresponds to UE ID based paging subgroup with identity 1, b2 corresponds to UE ID based paging subgroup with identity 2, b3 corresponds to UE ID based paging subgroup with identity 3, where bits in UEIDSubgroupingBitmap are numbered from b0 to b3 starting from least significant bit (as shown in a bitmap (103) of FIG. 1) or are numbered from b0 to b3 starting from most significant bit (as shown in a bitmap (203) of FIG. 2).

FIG. 3 illustrates a bitmap for paging subgroups in accordance with an embodiment of the disclosure.

In an embodiment, early paging indication (or paging DCI) includes a subgrouping bitmap (301). The bitmap is divided into two bitmaps CNSubgroupingBitmap (305) and UEIDSubgroupingBitmap (303). The size of subgrouping bitmap is equal to sum of maximum number of CN based paging subgroups and to sum of maximum number of UE ID based paging subgroups. The first ‘x’ bits starting from least significant bit in subgrouping bitmap corresponds to the UE ID based paging subgroups and sequentially mapped to UE ID based paging subgroup identities. The next ‘y’ bits subgrouping bitmap corresponds to the CN based paging subgroups and sequentially mapped to CN based paging subgroup identities. ‘x’ and ‘y’ are the maximum number of UE ID based paging subgroups and the maximum number of CN based paging subgroups, respectively. An example for x and y equal to 4 is shown in a bitmap (301) of FIG. 3.

FIG. 4 illustrates a bitmap for paging subgroups in accordance with an embodiment of the disclosure.

In an embodiment, early paging indication (or paging DCI) includes a subgrouping bitmap (401). The bitmap is divided into two bitmaps CNSubgroupingBitmap (403) and UE ID SubgroupingBitmap (405). The size of subgrouping bitmap is equal to sum of maximum number of CN based paging subgroups and to sum of maximum number of UE ID based paging subgroups. The first ‘x’ bits starting from least significant bit in subgrouping bitmap corresponds to CN based paging subgroups and sequentially mapped to CN based paging subgroup identity. The next ‘y’ bits subgrouping bitmap corresponds to UE ID based paging subgroups and sequentially mapped to UE ID based paging subgroup identity. ‘x’ and ‘y’ are the maximum number of CN based paging subgroups and the maximum number of UE ID based paging subgroups, respectively. An example for x and y equal to 4 is shown in FIG. 4.

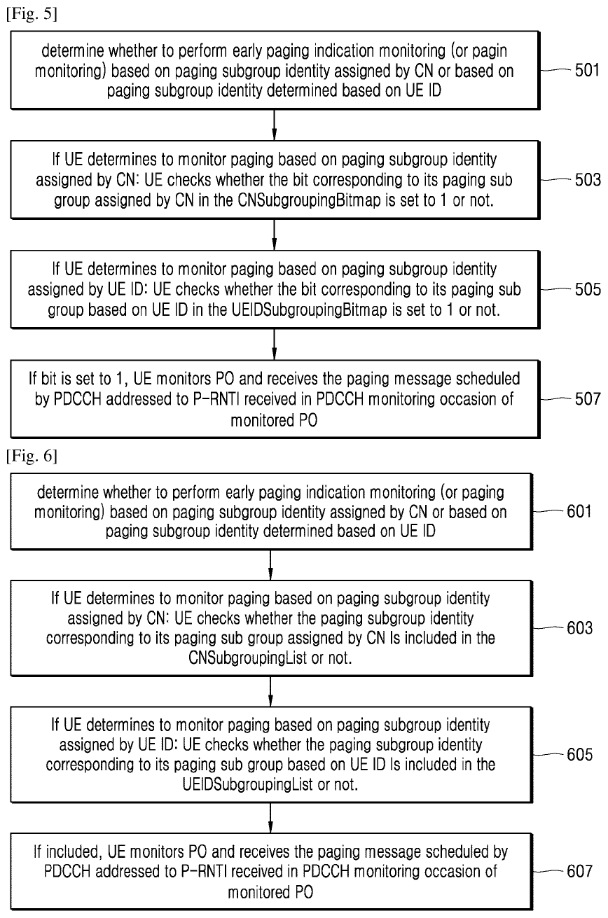

FIG. 5 illustrates a flow chart describing UE operation according to an embodiment of the disclosure.

In step 501, the UE determines whether to perform early paging indication monitoring (or paging monitoring) based on paging subgroup identity assigned by the CN or based on paging subgroup identity determined based on the UE ID.
CN assigned paging subgroup: Paging subgroup identity is assigned by CN (i.e. by AMF using NAS message) to UE
Paging subgroup determined based on UE ID: Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

UE belongs to subgroup ‘k’=└UE_ID/(N*Ns)┘ mod P, where
N is the number of Paging frames, Ns is the number of POs per paging frame and
P is the number of paging subgroups

If the UE has a paging subgrouping identity assigned by the CN and camped cell (i.e. cell on which UE monitors paging while the UE is in RRC_IDLE/RRC_INACTIVE) supports the CN assigned paging subgroups:
the UE performs early paging indication monitoring (or paging monitoring) based on the paging subgroup identity assigned by the CN.

If the UE does not have the paging subgrouping identity assigned by the CN (or the UE does not support the CN assigned paging subgrouping), the UE supports the UE ID based paging subgrouping and camped cell supports the UE ID based paging subgroups:
the UE performs early paging indication monitoring (or paging monitoring) based on the paging subgroup identity based on the UE ID.

In an embodiment, the network (e.g. gNB) may indicate (via RRC message or SI) whether the UE should use CN assigned paging subgroup or UE ID based paging subgroup (if the UE and the network both support the UE ID based and the CN assigned paging subgrouping).

Whether the cell supports the UE ID based paging subgroups and/or the CN assigned paging subgroups can be indicated in the system information or in the RRC Release message. In an embodiment, if the RRCRelease message indicates support for the UE ID based paging subgroups and/or the CN assigned paging subgroups, it is applied to all cells of RAN notification area to which the cell from which the RRCRelease message belongs. In an embodiment, if the RRCRelease message indicates support for the UE ID based paging subgroups and/or the CN assigned paging subgroups, it is applied to cell from which the RRCRelease message is received. In an embodiment, if the RRCRelease message indicates support for the UE ID based paging subgroups and/or the CN assigned paging subgroups, it is applied to cells indicated in the RRCRelease message.

The UE determines PF and PO as described earlier. The UE then identifies the occasion(s) (e.g. PDCCH monitoring occasions) for monitoring early paging indication corresponding to the determined PF/PO and monitors for early paging indication in the identified occasions if the early paging indication is supported by the camped cell. The UE receives the early paging indication.

In step 503, if the UE determines to monitor paging based on paging subgroup identity assigned by the CN
UE checks CNSubgroupingBitmap in the early paging indication (i.e. in DCI of PDCCH addressed to a pre-defined RNTI) to determine whether the early paging indication indicates paging for its paging subgroup assigned by the CN. The UE checks whether the bit corresponding to its paging subgroup assigned by the CN in the CN-SubgroupingBitmap is set to 1 or not.

If set to 1, the UE monitors PO and receives the paging message scheduled by PDCCH addressed to P-RNTI received in PDCCH monitoring occasion of monitored PO (step 507).
In an alternate embodiment, the UE checks CNSubgroupingBitmap in the paging DCI (i.e. in DCI of PDCCH addressed to a PRNTI transmitted in PO) to determine whether the paging DCI indicates paging for its paging subgroup assigned by CN. The UE checks whether the bit corresponding to its paging subgroup assigned by the CN in the CNSubgroupingBitmap is set to 1 or not. If set to 1, the UE receives the paging message scheduled by PDCCH addressed to P-RNTI received in PDCCH monitoring occasion of monitored PO.

In step 505, if UE determines to monitor paging based on paging subgroup identity based on UE ID
UE checks UEIDSubgroupingBitmap in the early paging indication (i.e. in DCI of PDCCH addressed to a pre-defined RNTI) to determine whether the early paging indication indicates paging for its paging subgroup determined based on UE ID. The UE checks whether the bit corresponding to its paging subgroup based on UE ID in the UEIDSubgroupingBitmap is set to 1 or not.

If set to 1, the UE monitors PO and receives the paging message scheduled by PDCCH addressed to P-RNTI received in PDCCH monitoring occasion of monitored PO. (step 507)
In an alternate embodiment, the UE checks UEIDSubgroupingBitmap in the paging DCI (i.e. in DCI of PDCCH addressed to PRNTI transmitted in PO) to determine whether the paging DCI indicates paging for its paging subgroup based on UE ID. The UE checks whether the bit corresponding to its paging subgroup based on UE ID in the UEIDSubgroupingBitmap is set to 1 or not. If set to 1, the UE receives the paging message scheduled by PDCCH addressed to P-RNTI received in PDCCH monitoring occasion of monitored PO.

The PDCCH for early paging indication is addressed to a pre-defined RNTI or RNTI signaled by the gNB in the system information. In an embodiment, there can be multiple RNTIs for monitoring early paging indication wherein a different RNTI is associated with a different PO of a PF. For example, if the PO index (i_s) determined by the UE is 0, the UE monitors PDCCH addressed to first RNTI in the PDCCH monitoring occasion of early paging indication; if the PO index (i_s) determined by the UE is 1, the UE monitors PDCCH addressed to second RNTI in the PDCCH monitoring occasion of early paging indication; if the PO index (i_s) determined by the UE is 2, the UE monitors PDCCH addressed to third RNTI in the PDCCH monitoring occasion of early paging indication, if the PO index (i_s) determined by the UE is 3, the UE monitors PDCCH addressed to four RNTI in the PDCCH monitoring occasion of early paging indication. The first, second, third and fourth RNTI can be pre-defined or signaled by the gNB in the system information/RRC message. List of RNTIs for early paging indication can be signaled by the gNB in the system information/RRC message wherein the first entry in the list corresponds to 1^{st} PO (i.e. PO with index i_s=0), second entry in the list corresponds to 2^{nd} PO (i.e. PO with index i_s=1), third entry in the list corresponds to 3^{rd} PO (i.e. PO with index i_s=2) and fourth entry in the list corresponds to 4^{th} PO (i.e. PO with index i_s=3).

In this method of the disclosure, for paging a UE, the gNB first determines whether to page UE based on paging subgroup identity assigned by CN or based on paging subgroup identity determined based on UE ID.

If UE to be paged has a paging subgrouping identity assigned by the CN and the gNB supports CN assigned paging subgroups
the gNB may page the UE based on paging subgroup identity assigned by CN

If UE to be paged does not have paging subgrouping identity assigned by CN (or UE does not support CN assigned paging subgrouping) and the UE supports UE ID based paging subgrouping and gNB supports supports UE ID based paging subgroups
the gNB may page the UE based on paging subgroup identity based on UE ID.

The gNB may determine that the UE has paging subgrouping identity assigned by the CN, if UE's paging subgroup identity is received by the gNB in paging message from the AMF in case of CN paging or if UE's paging subgroup identity is received by the gNB in assistance information from the AMF in case of RAN paging. Whether UE supports UE ID based paging subgrouping can also be received from the AMF in the paging message or the assistance information from the AMF or can be received from the UE in UE capability information message.

The gNB determines PF and PO as described earlier for the UE to be paged. The gNB then identifies the occasion(s) for early paging indication corresponding to the determined PF/PO.

If the gNB determines to page the UE based on paging subgroup identity assigned by CN
the gNB sets the bit corresponding to UE's paging subgroup assigned by the CN in the CNSubgroupingBitmap. CNSubgroupingBitmap is included in DCI of early paging indication or paging DCI. Early paging indication is transmitted in occasion(s) for early paging indication. Paging DCI is transmitted in occasions for PO.

If the gNB determines to page UE based on paging subgroup identity based on UE ID
the gNB sets the bit corresponding to UE's paging subgroup based on UE ID in the UEID SubgroupingBitmap. UE IDSubgroupingBitmap is included in DCI of early paging indication or paging DCI. Early paging indication is transmitted in occasion(s) for early paging indication. Paging DCI is transmitted in occasions for PO.

In an embodiment, wherein the paging subgroup is indicated by a sequence, bit corresponding to paging subgroup in bitmap can be replaced by a sequence corresponding to paging subgroup in the above description.

### Method 2

In one method of this disclosure, early paging indication (or paging DCI) includes separate paging subgroup list for the CN assigned paging subgroups and the UE ID based paging subgroups. The list for the CN assigned paging subgroups can be referred as CNSubgroupingList. The list for the UE ID based paging subgroups can be referred as UEIDSubgroupingList. Each list includes the identities of paging subgroups which are paged.

Each paging subgroup identity in CNSubgroupingList corresponds to a paging subgroup assigned by the CN. Each paging subgroup identity in UEIDSubgroupingList corresponds to a paging subgroup determined based on UE ID.

FIG. 6 illustrates a flow chart describing UE operation according to an embodiment of the disclosure.

In this method of disclosure, in step 601, the UE determines whether to perform early paging indication monitoring (or paging monitoring) based on paging subgroup identity assigned by CN or based on paging subgroup identity determined based on UE ID.
CN assigned paging subgroup: Paging subgroup identity is assigned by CN (i.e. by AMF using NAS message) to UE
Paging subgroup determined based on UE ID: Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

UE belongs to subgroup ‘k’=└UE_ID/(N*Ns)┘ mod P, where
N is the number of Paging frames, Ns is the number of POs per paging frame and
P is the number of paging subgroups

If UE has a paging subgrouping identity assigned by CN and camped cell (i.e. the cell on which UE monitors paging while the UE is in RRC_IDLE/RRC_CONNECTED) supports CN assigned paging subgroups
UE performs early paging indication monitoring (or paging monitoring) based on paging subgroup identity assigned by CN

If UE does not have paging subgrouping identity assigned by CN (or UE does not support CN assigned paging subgrouping) and UE supports UE ID based paging subgrouping and camped cell supports UE ID based paging subgroups
UE performs early paging indication monitoring (or paging monitoring) based on paging subgroup identity based on UE ID.

In an embodiment, network (e.g. gNB) may indicate (via RRC message or SI) whether UE should use CN assigned paging subgroup or UE ID based paging subgroup (if UE and network both supports UE ID based and CN assigned paging subgrouping).

Whether the cell supports UE ID based paging subgroups and/or CN assigned paging subgroups can be indicated in system information or in RRC Release message. In an embodiment, if RRCRelease message indicates support for UE ID based paging subgroups and/or CN assigned paging subgroups, it is applied to all cells of RAN notification area to which the cell from which RRCRelease message belongs. In an embodiment, if RRCRelease message indicates support for UE ID based paging subgroups and/or CN assigned paging subgroups, it is applied to cell from which RRCRelease message is received. In an embodiment, if RRCRelease message indicates support for UE ID based paging subgroups and/or CN assigned paging subgroups, it is applied to cells indicated in RRCRelease message.

UE determines PF and PO as described earlier. UE then identifies the occasion(s) for monitoring early paging indication corresponding to the determined PF/PO and monitors for early paging indication in the identified occasions. UE receives early paging indication.

In step 603, if the UE determines to monitor paging based on paging subgroup identity assigned by the CN
the UE checks CNSubgroupingList in the early paging indication (i.e. in DCI of PDCCH addressed to a pre-defined RNTI) to determine whether the early paging indication indicates paging for its paging subgroup assigned by the CN. The UE checks whether the paging subgroup identity corresponding to its paging subgroup assigned by the CN is included in the CNSubgroupingList or not. If included, the UE monitors PO and receives the paging message scheduled by PDCCH addressed to P-RNTI received in PDCCH monitoring occasion of monitored PO. (step 607)
In an alternate embodiment, the UE checks CNSubgroupingList in the paging DCI (i.e. in DCI of PDCCH addressed to a pre-PRNTI transmitted in PO) to determine whether the paging DCI indicates paging for its paging subgroup assigned by the CN. The UE checks whether the paging subgroup identity corresponding to its paging subgroup assigned by the CN is included in the CNSubgroupingList or not. If included, the UE receives the paging message scheduled by PDCCH addressed to P-RNTI received in PDCCH monitoring occasion of monitored PO.

In step 605, if the UE determines to monitor paging based on paging subgroup identity based on UE ID
the UE checks UEIDSubgroupingList in the early paging indication (i.e. in DCI of PDCCH addressed to a pre-defined RNTI) to determine whether the early paging indication indicates paging for its paging subgroup based on UE ID. The UE checks whether the paging subgroup identity corresponding to its paging subgroup based on UE ID is included in the UEIDSubgroupingList or not. If included, the UE monitors PO and receives the paging message scheduled by PDCCH addressed to P-RNTI received in PDCCH monitoring occasion of monitored PO. (step 607)
In an alternate embodiment, the UE checks UEIDSubgroupingList in the paging DCI (i.e. in DCI of PDCCH addressed to a pre-PRNTI transmitted in PO) to determine whether the paging DCI indicates paging for its paging subgroup based on UE ID. The UE checks whether the paging subgroup identity corresponding to its paging subgroup based on UE ID is included in the UEIDSubgroupingList or not. If included, the UE receives the paging message scheduled by PDCCH addressed to P-RNTI received in PDCCH monitoring occasion of monitored PO.

The PDCCH for early paging indication is addressed to a pre-defined RNTI or RNTI signaled by gNB in system information. In an embodiment, there can be multiple RNTIs for monitoring early paging indication wherein a different RNTI is associated with a different PO of a PF. For example, if the PO index (i_s) determined by UE is 0, UE monitors PDCCH addressed to first RNTI in the PDCCH monitoring occasion of early paging indication; if the if the PO index (i_s) determined by UE is 1, UE monitors PDCCH addressed to second RNTI in the PDCCH monitoring occasion of early paging indication; if the PO index (i_s) determined by UE is 2, UE monitors PDCCH addressed to third RNTI in the PDCCH monitoring occasion of early paging indication, if the PO index (i_s) determined by UE is 3, UE monitors PDCCH addressed to fourth RNTI in the PDCCH monitoring occasion of early paging indication. The first, second, third and fourth RNTI can be pre-defined or signaled by gNB in system information/RRC message. List of RNTIs for early paging indication can be signaled by GNB in system information/RRC message wherein the first entry in list corresponds to 1^{st} PO (i.e. PO with index i_s=0), second entry in list corresponds to 2^{nd} PO (i.e. PO with index i_s=1), third entry in list corresponds to 3^{rd} PO (i.e. PO with index i_s=2) and fourth entry in list corresponds to 4^{th} PO (i.e. PO with index i_s=3).

In this method of disclosure, for paging a UE, the gNB first determines whether to page UE based on paging subgroup identity assigned by CN or based on paging subgroup identity determined based on UE ID.

If UE to be paged has a paging subgrouping identity assigned by CN and gNB supports CN assigned paging subgroups
gNB page UE based on paging subgroup identity assigned by CN

If UE to be paged does not have paging subgrouping identity assigned by CN (or UE does not support CN assigned paging subgrouping) and UE supports UE ID based paging subgrouping and gNB supports UE ID based paging subgroups
gNB page UE based on paging subgroup identity based on UE ID.

The gNB may determine that the UE has paging subgrouping identity assigned by CN, if UE's paging subgroup identity is received by the gNB in paging message from the AMF in case of CN paging or if UE's paging subgroup identity is received by the gNB in assistance information from the AMF in case of RAN paging. Whether UE supports UE ID based paging subgrouping can also be received from AMF in paging message or assistance information from AMF or can be received from UE in UE capability information message.

The gNB determines PF and PO as described earlier for the UE to be paged. The gNB then identifies the occasion(s) for early paging indication corresponding to the determined PF/PO.

If the gNB determines to page UE based on paging subgroup identity assigned by CN
gNB includes the paging subgroup identity corresponding to UE's paging subgroup assigned by CN in the CNSubgroupingList. CNSubgroupingList is included in DCI of early paging indication or paging DCI. Early paging indication is transmitted in occasion(s) for early paging indication. Paging DCI is transmitted in occasions for PO.

If the gNB determines to page UE based on paging subgroup identity based on UE ID
gNB includes the paging subgroup identity corresponding to UE's paging subgroup based on UE ID in the UEID SubgroupingList. UEIDSubgroupingList is included in DCI of early paging indication or paging DCI. Early paging indication is transmitted in occasion(s) for early paging indication. Paging DCI is transmitted in occasions for PO.

### Method 3

In one method of this disclosure, early paging indication (or paging DCI) includes a bitmap for paging subgroups. The length of bitmap depends on number of paging subgroups. If the maximum number of paging subgroups is ‘x’, the size of bitmap is ‘x’ bits. Each bit in bitmap corresponds to a paging subgroup identity. k^{th} bit (from least significant bit or from most significant bit) in bitmap corresponds to paging subgroup with identity k. k is integer. Paging subgroup identity can be determined in one of the following ways:
CN assigned paging subgroup: Paging sub group identity is assigned by CN (i.e. by AMF using NAS message) to UE
Paging subgroup determined based on UE ID: Paging sub group identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

UE belongs to subgroup ‘k’=(└UE_ID/(N+Ns)┘ mod P)+Offset, where
N is the number of Paging frames, Ns is the number of POs per paging frame and
P is the number of paging sub groups based on UE ID. N, Ns and P is signaled by gNB in system information.

Offset is signaled by the gNB in the system information. The Offset can be signaled by the AMF in the NAS signaling. The Offset can be equal to the number of CN assigned paging subgroups where the number of CN assigned paging subgroups is signaled or informed by the AMF in the NAS signaling. The Offset can be equal to the number of CN assigned paging subgroups where the number of CN assigned paging subgroups is signaled or informed by the gNB in the system information. The gNB can explicitly signal a parameter whose value is equal to number of CN assigned paging subgroups. Alternately, the gNB can signal a first parameter whose value is equal to total number of paging subgroups (i.e. sum of number of UE ID based paging subgroups and number of CN assigned paging subgroups) and a second parameter whose value is equal to number of UE ID based paging subgroups. The difference of first and second parameters values is equal to number of CN assigned paging subgroups.

In an embodiment, the offset can be zero and CN based paging subgroup identity starts from K where K>=the number of UE ID based paging subgroups.

The UE determines whether to perform early paging indication monitoring (or paging monitoring) based on paging subgroup identity assigned by CN or based on paging subgroup identity determined based on UE ID.

If UE has a paging subgrouping identity assigned by CN and camped cell supports CN assigned paging subgroups:
UE performs early paging indication monitoring (or paging monitoring) based on paging subgroup identity assigned by CN

If UE does not have paging subgrouping identity assigned by CN (or UE does not support CN assigned paging subgrouping) and UE supports UE ID based paging subgrouping and camped cell supports UE ID based paging subgroups:
UE performs early paging indication monitoring (or paging monitoring) based on paging subgroup identity based on UE ID.

Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

UE belongs to subgroup ‘k’=(└UE_ID/(N*Ns)┘ mod P)+Offset, where
N is the number of Paging frames, Ns is the number of POs per paging frame and
P is the number of paging subgroups based on UE ID. N, Ns and P is signaled by the gNB in the system information.

Offset is signaled by the gNB in the system information. Offset can be signaled by AMF in the NAS signaling. Offset can be equal to the number of CN assigned paging subgroups where the number of CN assigned paging subgroups is signaled or informed by the AMF in the NAS signaling. Offset can be equal to the number of CN assigned paging subgroups where the number of CN assigned paging subgroups is signaled or informed by the gNB in the system information. The gNB can explicitly signal a parameter whose value is equal to number of CN assigned paging subgroups. Alternately, the gNB can signal a first parameter whose value is equal to total number of paging subgroups (i.e. sum of number of UE ID based paging subgroups and number of CN assigned paging subgroups) and a second parameter whose value is equal to number of UE ID based paging subgroups. The difference of first and second parameters values is equal to number of CN assigned paging subgroups.

In an embodiment, the network (e.g. gNB) may indicate (via RRC message or SI) whether the UE should use CN assigned paging subgroup or UE ID based paging subgroup (if UE and network both supports UE ID based and CN assigned paging subgrouping).

Whether the cell supports UE ID based paging subgroups and/or CN assigned paging subgroups can be indicated in the system information or in the RRC Release message. In an embodiment, if the RRCRelease message indicates support for the UE ID based paging subgroups and/or the CN assigned paging subgroups, it is applied to all cells of RAN notification area to which the cell from which the RRCRelease message belongs. In an embodiment, if the RRCRelease message indicates support for the UE ID based paging subgroups and/or the CN assigned paging subgroups, it is applied to cell from which the RRCRelease message is received. In an embodiment, if the RRCRelease message indicates support for the UE ID based paging subgroups and/or the CN assigned paging subgroups, it is applied to cells indicated in the RRCRelease message.

The UE determines PF and PO as described earlier. The UE then identifies the occasion(s) for monitoring early paging indication corresponding to the determined PF/PO and monitors for the early paging indication in the identified occasions if the the early paging indication is supported by the camped cell. The UE receives the early paging indication.

If the UE determines to monitor paging based on paging subgroup identity assigned by CN
the UE checks SubgroupingBitmap in the early paging indication (i.e. in DCI of PDCCH addressed to a pre-defined RNTI) to determine whether the early paging indication indicates paging for its paging subgroup assigned by the CN. The UE checks whether the bit corresponding to its paging subgroup identity assigned by the CN in the SubgroupingBitmap is set to 1 or not. If set to 1, the UE monitors PO and receives the paging message scheduled by PDCCH addressed to P-RNTI received in PDCCH monitoring occasion of monitored PO.
In an alternate embodiment, the UE checks SubgroupingBitmap in the paging DCI (i.e. in DCI of PDCCH addressed to a PRNTI transmitted in PO) to determine whether the paging DCI indicates paging for its paging subgroup assigned by the CN. The UE checks whether the bit corresponding to its paging subgroup identity assigned by the CN in the SubgroupingBitmap is set to 1 or not. If set to 1, the UE receives the paging message scheduled by PDCCH addressed to P-RNTI received in PDCCH monitoring occasion of monitored PO.

If the UE determines to monitor paging based on paging subgroup identity based on UE ID
the UE checks SubgroupingBitmap in the early paging indication (i.e. in DCI of PDCCH addressed to a pre-defined RNTI) to determine whether the early paging indication indicates paging for its paging subgroup identity determined based on the UE ID. The UE checks whether the bit corresponding to its paging subgroup based on the UE ID in the SubgroupingBitmap is set to 1 or not. If set to 1, the UE monitors PO and receives the paging message scheduled by PDCCH addressed to P-RNTI received in PDCCH monitoring occasion of monitored PO.
In an alternate embodiment, the UE checks SubgroupingBitmap in the paging DCI (i.e. in DCI of PDCCH addressed to a PRNTI transmitted in PO) to determine whether the paging DCI indicates paging for its paging subgroup based on the UE ID. The UE checks whether the bit corresponding to its paging subgroup identity based on the UE ID in the SubgroupingBitmap is set to 1 or not. If set to 1, the UE receives the paging message scheduled by PDCCH addressed to P-RNTI received in PDCCH monitoring occasion of monitored PO.

The PDCCH for early paging indication is addressed to a pre-defined RNTI or RNTI signaled by the gNB in the system information. In an embodiment, there can be multiple RNTIs for monitoring early paging indication wherein a different RNTI is associated with a different PO of a PF. For example, if the PO index (i_s) determined by the UE is 0, the UE monitors PDCCH addressed to first RNTI in the PDCCH monitoring occasion of the early paging indication; if the PO index (i_s) determined by the UE is 1, the UE monitors PDCCH addressed to second RNTI in the PDCCH monitoring occasion of the early paging indication; if the PO index (i_s) determined by the UE is 2, the UE monitors PDCCH addressed to third RNTI in the PDCCH monitoring occasion of the early paging indication, if the PO index (i_s) determined by the UE is 3, UE monitors PDCCH addressed to fourth RNTI in the PDCCH monitoring occasion of the early paging indication. The first, second, third and fourth RNTIs can be pre-defined or signaled by the gNB in the system information or an RRC message. List of RNTIs for early paging indication can be signaled by the gNB in the system information or the RRC message wherein the first entry in the list corresponds to 1^{st} PO (i.e. PO with index i_s=0), second entry in the list corresponds to 2^{nd} PO (i.e. PO with index i_s=1), third entry in the list corresponds to 3^{rd} PO (i.e. PO with index i_s=2) and fourth entry in the list corresponds to 4^{th} PO (i.e. PO with index i_s=3).

In this method of disclosure, for paging a UE, the gNB first determines whether to page UE based on paging subgroup identity assigned by the CN or based on paging subgroup identity determined based on the UE ID.

If UE to be paged has a paging subgrouping identity assigned by the CN and the gNB supports CN assigned paging subgroups
the gNB pages the UE based on the paging subgroup identity assigned by the CN

If UE to be paged does not have paging subgrouping identity assigned by the CN (or the UE does not support CN assigned paging subgrouping) and the UE supports UE ID based paging subgrouping and the gNB supports UE ID based paging subgroups
the gNB pages UE based on the paging subgroup identity based on the UE ID.

Paging subgroup identity is determined based on the UE_ID (UE_ID is 5G-S-TMSI or 5G-S-TMSI mod X, where X is 1024 or 2048 or 4096 or N*Ns*P or Max value of N*Max value of Ns*Max value of P)

UE belongs to subgroup ‘k’=(└UE_ID/(N*Ns)┘ mod P)+Offset, where
N is the number of Paging frames, Ns is the number of POs per paging frame and
P is the number of paging sub groups based on UE ID. N, Ns and P are signaled by the gNB in the system information.

Offset is signaled by the gNB in the system information. Offset can be signaled by AMF to the gNB in paging message or assistance information message. Offset can be equal to the number of CN assigned paging subgroups where the number of CN assigned paging subgroups is signaled or informed by the AMF to the gNB in paging message or assistance information message.

The gNB determines that the UE has paging subgrouping identity assigned by the CN, if UE's paging subgroup identity is received by the gNB in paging message from the AMF in case of CN paging or if UE's paging subgroup identity is received by the gNB in assistance information from the AMF in case of RAN paging. Whether the UE supports UE ID based paging subgrouping can also be received from the AMF in the paging message or the assistance information from the AMF or can be received from the UE in UE capability information message.

The gNB determines PF and PO as described earlier for the UE to be paged. The gNB then identifies the occasion(s) for early paging indication corresponding to the determined PF/PO.

If the gNB determines to page UE based on paging subgroup identity assigned by the CN
the gNB sets the bit corresponding to UE's paging subgroup assigned by the CN in the SubgroupingBitmap. SubgroupingBitmap is included in DCI of early paging indication or paging DCI.

If the gNB determines to page UE based on paging subgroup identity based on UE ID
the gNB sets the bit corresponding to UE's paging subgroup based on UE ID in the SubgroupingBitmap. SubgroupingBitmap is included in DCI of early paging indication or paging DCI.

### Method 4

In one method of this disclosure, early paging indication (or paging DCI) includes a bitmap for paging subgroups. The length of the bitmap depends on the number of paging subgroups. If the maximum number of the paging subgroups is ‘x’, the size of bitmap is ‘x’ bits. Each bit in bitmap corresponds to a paging subgroup identity. kth bit (from least significant bit or from most significant bit) in the bitmap corresponds to paging subgroup with identity k. k is integer. Paging subgroup identity can be determined in one of the following ways:
CN assigned paging subgroup: Paging subgroup identity is assigned by CN (i.e. by AMF using NAS message) to UE
Paging subgroup determined based on UE ID: Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

UE calculates index ‘i’=└UE_ID/(N*Ns)┘ mod P, where
N is the number of Paging frames, Ns is the number of POs per paging frame and
P is the number of paging subgroups based on the UE ID. N, Ns is signaled by the gNB in the system information.

The calculated value of ‘i’ is greater than or equal to zero and less than P. P is the number of UE ID based paging groups.

The gNB signals (e.g. in SI) list of paging subgroup IDs (PagingSubGroupIDList) for UE ID based subgrouping. UE's paging subgroup is the subgroup in the i+1^{th} entry in the list of paging subgroup IDs. P is the number of UE ID based paging groups i.e. size of PagingSubGroupIDList. For example, if the size of PagingSubGroupIDList is 4, it contains 4 entries (numbered from 1 to 4). If the index ‘i’ calculated by the UE is 2, UE's paging subgroup identity is the 3^{rd} paging subgroup in the PagingSubGroupIDList.

(Alt) The gNB signals (e.g. in SI) list of paging subgroup IDs (PagingSubGroupIDList) for UE ID based subgrouping. UE's paging subgroup is the subgroup in the i^{th} entry in list of paging subgroup IDs. P is the number of UE ID based paging groups i.e. size of PagingSubGroupIDList. For example, if the size of PagingSubGroupIDList is 4, it contains 4 entries (numbered from 0 to 3). If the index ‘i’ calculated by the UE is 2, UE's paging subgroup identity is the paging subgroup in the entry number 2 in the PagingSubGroupIDList.

The UE determines whether to perform early paging indication monitoring (or paging monitoring) based on paging subgroup identity assigned by the CN or based on paging subgroup identity determined based on the UE ID.

If the UE has a paging subgrouping identity assigned by the CN and camped cell supports CN assigned paging subgroups:
the UE performs early paging indication monitoring (or paging monitoring) based on paging subgroup identity assigned by the CN

If the UE does not have paging subgrouping identity assigned by the CN (or UE does not support CN assigned paging subgrouping) and the UE supports UE ID based paging subgrouping and camped cell supports UE ID based paging subgroups:
the UE performs early paging indication monitoring (or paging monitoring) based on paging subgroup identity based on UE ID.

Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

The UE calculates index ‘i’=└UE_ID/(N*Ns)┘ mod P, where
N is the number of Paging frames, Ns is the number of POs per paging frame and
P is the number of paging subgroups based on UE ID. N Ns and P are signaled by the gNB in the system information.

The calculated value of ‘i’ is greater than equal to zero and less than P. P is the number of UE ID based paging subgroups.

The gNB signals (e.g. in SI) list of paging subgroup IDs (PagingSubGroupIDList) for UE ID based subgrouping. UE's paging subgroup is the subgroup in the i+1^{th} entry in the list of paging subgroup IDs. P is the number of UE ID based paging subgroups i.e. size of PagingSubGroupIDList. For example, if the size of PagingSubGroupIDList is 4, it contains 4 entries (numbered from 1 to 4). If the index ‘i’ calculated by the UE is 2, UE's paging subgroup identity is the 3^{rd} paging subgroup in the PagingSubGroupIDList.

(Alt) The gNB signals (e.g. in SI) list of paging subgroup IDs (PagingSubGroupIDList) for UE ID based subgrouping. UE's paging subgroup is the subgroup in the i^{th} entry in the list of paging subgroup IDs. P is the number of UE ID based paging groups i.e. size of PagingSubGroupIDList. For example, if the size of PagingSubGroupIDList is 4, it contains 4 entries (numbered from 0 to 3). If the index ‘i’ calculated by the UE is 2, UE's paging subgroup identity is the paging subgroup in the entry number 2 in the PagingSubGroupIDList.

In an embodiment, the network (e.g. gNB) may indicate (via RRC message or SI) whether the UE should use CN assigned paging subgroup or UE ID based paging subgroup (if the UE and the network both support UE ID based and CN assigned paging subgrouping).

Whether the cell supports UE ID based paging subgroups and/or CN assigned paging subgroups can be indicated in the system information or in the RRC Release message. In an embodiment, if the RRCRelease message indicates support for UE ID based paging subgroups and/or CN assigned paging subgroups, it is applied to all cells of RAN notification area to which the cell from which the RRCRelease message belongs. In an embodiment, if the RRCRelease message indicates support for UE ID based paging subgroups and/or CN assigned paging subgroups, it is applied to cell from which the RRCRelease message is received. In an embodiment, if the RRCRelease message indicates support for UE ID based paging subgroups and/or CN assigned paging subgroups, it is applied to cells indicated in the RRCRelease message.

The UE determines PF and PO as described earlier. The UE then identifies the occasion(s) for monitoring early paging indication corresponding to the determined PF/PO and monitors for the early paging indication in the identified occasions if the early paging indication is supported by the camped cell. The UE receives the early paging indication.

If the UE determines to monitor paging based on paging subgroup identity assigned by CN
the UE checks SubgroupingBitmap in the early paging indication (i.e. in DCI of PDCCH addressed to a pre-defined RNTI) to determine whether the early paging indication indicates paging for its paging subgroup assigned by the CN. The UE checks whether the bit corresponding to its paging subgroup identity assigned by the CN in the SubgroupingBitmap is set to 1 or not. If set to 1, the UE monitors PO and receives the paging message scheduled by PDCCH addressed to P-RNTI received in PDCCH monitoring occasion of monitored PO.
In an alternate embodiment, the UE checks SubgroupingBitmap in the paging DCI (i.e. in DCI of PDCCH addressed to a PRNTI transmitted in PO) to determine whether the paging DCI indicates paging for its paging subgroup assigned by the CN. The UE checks whether the bit corresponding to its paging subgroup identity assigned by the CN in the SubgroupingBitmap is set to 1 or not. If set to 1, the UE receives the paging message scheduled by PDCCH addressed to P-RNTI received in PDCCH monitoring occasion of monitored PO.

If the UE determines to monitor paging based on paging subgroup identity based on UE ID
the UE checks SubgroupingBitmap in the early paging indication (i.e. in DCI of PDCCH addressed to a pre-defined RNTI) to determine whether the early paging indication indicates paging for its paging subgroup identity determined based on UE ID. The UE checks whether the bit corresponding to its paging subgroup based on UE ID in the SubgroupingBitmap is set to 1 or not. If set to 1, the UE monitors PO and receives the paging message scheduled by PDCCH addressed to P-RNTI received in PDCCH monitoring occasion of monitored PO.
In an alternate embodiment, the UE checks SubgroupingBitmap in the paging DCI (i.e. in DCI of PDCCH addressed to a PRNTI transmitted in PO) to determine whether the paging DCI indicates paging for its paging subgroup based on UE ID. The UE checks whether the bit corresponding to its paging subgroup identity based on the UE ID in the SubgroupingBitmap is set to 1 or not. If set to 1, the UE receives the paging message scheduled by PDCCH addressed to P-RNTI received in PDCCH monitoring occasion of monitored PO.

The PDCCH for the early paging indication is addressed to a pre-defined RNTI or RNTI signaled by the gNB in the system information. In an embodiment, there can be multiple RNTIs for monitoring the early paging indication wherein a different RNTI is associated with a different PO of a PF. For example, if the PO index (i_s) determined by UE is 0, the UE monitors PDCCH addressed to first RNTI in the PDCCH monitoring occasion of early paging indication; if the PO index (i_s) determined by the UE is 1, the UE monitors PDCCH addressed to second RNTI in the PDCCH monitoring occasion of the early paging indication; if the PO index (i_s) determined by the UE is 2, the UE monitors PDCCH addressed to third RNTI in the PDCCH monitoring occasion of the early paging indication, if the PO index (i_s) determined by the UE is 3, the UE monitors PDCCH addressed to fourth RNTI in the PDCCH monitoring occasion of early paging indication. The first, second, third and fourth RNTI can be pre-defined or signaled by the gNB in the system information or the RRC message. List of RNTIs for the early paging indication can be signaled by the gNB in the system information/RRC message wherein the first entry in the list corresponds to 1^{st} PO (i.e. PO with index i_s=0), second entry in list corresponds to 2^{nd} PO (i.e. PO with index i_s=1), third entry in the list corresponds to 3^{rd} PO (i.e. PO with index i_s=2) and fourth entry in list corresponds to 4^{th} PO (i.e. PO with index i_s=3).

In this method of disclosure, for paging a UE, the gNB first determines whether to page UE based on paging subgroup identity assigned by CN or based on paging subgroup identity determined based on UE ID.

If UE to be paged has a paging subgrouping identity assigned by the CN and the gNB supports CN assigned paging subgroups
the gNB pages UE based on paging subgroup identity assigned by the CN

If UE to be paged does not have paging subgrouping identity assigned by the CN (or the UE does not support CN assigned paging subgrouping) and the UE supports UE ID based paging subgrouping and the gNB supports UE ID based paging subgroups
the gNB pages UE based on paging subgroup identity based on the UE ID which is determined as follows:

Paging subgroup identity is determined based on UE_ID (UE_ID is 5G-S-TMSI or 5G-S-TMSI mod X, where X is 1024 or 2048 or 4096 or N*Ns*P or Max value of N*Max value of Ns*Max value of P)

index ‘i’=└UE_ID/(N*Ns)┘ mod P, where
N is the number of Paging frames, Ns is the number of POs per paging frame and
P is the number of paging subgroups based on UE ID. N, Ns and P are signaled by the gNB in the system information.

The calculated value of ‘i’ is greater than or equal to zero and less than P. P is the number of UE ID based paging subgroups.

The gNB signals (e.g. in SI) list of paging subgroup IDs (PagingSubGroupIDList) for UE ID based subgrouping. UE's paging subgroup is the subgroup in the i+1^{th} entry in the list of paging subgroup IDs. P is the number of UE ID based paging groups i.e. size of PagingSubGroupIDList. For example, if the size of PagingSubGroupIDList is 4, it contains 4 entries (numbered from 1 to 4). If the index ‘i’ calculated by the UE is 2, UE's paging subgroup identity is the 3^{rd} paging subgroup in the PagingSubGroupIDList.

(Alt) The gNB signals (e.g. in SI) list of paging subgroup IDs (PagingSubGroupIDList) for UE ID based subgrouping. UE's paging subgroup is the subgroup in the i^{th} entry in the list of paging subgroup IDs. P is the number of UE ID based paging subgroups i.e. size of PagingSubGroupIDList. For example, if the size of PagingSubGroupIDList is 4, it contains 4 entries (numbered from 0 to 3). If the index ‘i’ calculated by the UE is 2, UE's paging subgroup identity is the paging subgroup in the entry number 2 in the PagingSubGroupIDList.

The gNB determines that the UE has paging subgrouping identity assigned by the CN, if UE's paging subgroup identity is received by the gNB in a paging message from the AMF in case of CN paging or if UE's paging subgroup identity is received by the gNB in assistance information from the AMF in case of RAN paging. Whether the UE supports UE ID based paging subgrouping can also be received from the AMF in the paging message or the assistance information from the AMF or can be received from the UE in UE capability information message.

The gNB determines PF and PO as described earlier for the UE to be paged. The gNB then identifies the occasion(s) for early paging indication corresponding to the determined PF/PO.

If the gNB determines to page UE based on paging subgroup identity assigned by the CN
the gNB sets the bit corresponding to UE's paging subgroup assigned by the CN in the SubgroupingBitmap. SubgroupingBitmap is included in DCI of early paging indication or paging DCI. Early paging indication is transmitted in occasion(s) for early paging indication. Paging DCI is transmitted in occasions for PO.

If the gNB determines to page UE based on paging subgroup identity based on UE ID

the gNB sets the bit corresponding to UE's paging sub group based on UE ID in the SubgroupingBitmap. SubgroupingBitmap is included in DCI of early paging indication or paging DCI. Early paging indication is transmitted in occasion(s) for early paging indication. Paging DCI is transmitted in occasions for PO.

In accordance with an embodiment of the disclosure, a method performed by a user equipment (UE) in a wireless communication system is provided. The method may comprise: receiving, from a base station, system information associated with a paging subgroup; identifying a value associated with a number of paging subgroups for a core network (CN) assigned subgrouping, based on the system information; and determining a paging subgroup identification (ID) associated with a UE ID based subgrouping, based on the identified value.

In an embodiment, wherein the UE is not configured with a CN assigned subgroup ID.

In an embodiment, wherein the UE is in a cell supporting the UE ID based subgrouping.

In an embodiment, the method may further comprise receiving, from the base station, paging early indication (PEI) information including a bit corresponding to the paging subgroup ID.

In an embodiment, wherein the bit indicates the UE belonging to the paging subgroup ID to monitor a paging occasion (PO) associated with the PEI information.

In an embodiment, the method may further comprise monitoring the PO for receiving a paging message, based on the PEI information.

In accordance with an embodiment of the disclosure, a user equipment (UE) in a wireless communication system is provided. The UE may comprise: a transceiver; and at least one processor configured to: receive, from a base station via the transceiver, system information associated with a paging subgroup; identify a value associated with a number of paging subgroups for a core network (CN) assigned subgrouping, based on the system information; and determine a paging subgroup identification (ID) associated with a UE ID based subgrouping, based on the identified value.

In an embodiment, wherein the UE is not configured with a CN assigned subgroup ID.

In an embodiment, wherein the UE is in a cell supporting the UE ID based subgrouping.

In an embodiment, wherein the processor is further configured to: receive, from the base station via the transceiver, paging early indication (PEI) information including a bit corresponding to the paging subgroup ID.

In an embodiment, wherein the bit indicates the UE belonging to the paging subgroup ID to monitor a paging occasion (PO) associated with the PEI information.

In an embodiment, wherein the processor is further configured to: monitor the PO for receiving a paging message, based on the PEI information.

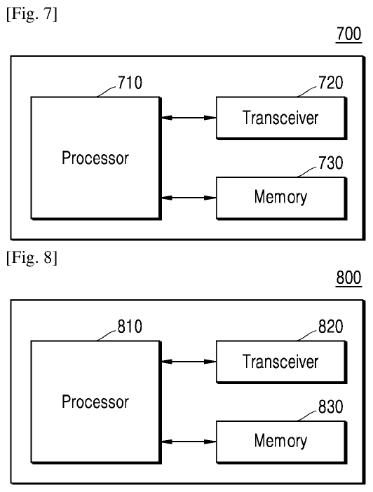

FIG. 7 is a diagram illustrating a UE 700 according to an embodiment of the present disclosure.

Referring to the FIG. 7, the UE 700 may include a processor 710, a transceiver 720 and a memory 730. However, all of the illustrated components are not essential. The UE 700 may be implemented by more or less components than those illustrated in the FIG. 7. In addition, the processor 710 and the transceiver 720 and the memory 730 may be implemented as a single chip according to another embodiment.

The aforementioned components will now be described in detail.

The processor 710 may include one or more processors or other processing devices that control the proposed function, process, and/or method. Operation of the UE 700 may be implemented by the processor 710.

The transceiver 720 may be connected to the processor 710 and transmit and/or receive a signal. In addition, the transceiver 720 may receive the signal through a wireless channel and output the signal to the processor 710. The transceiver 720 may transmit the signal output from the processor 710 through the wireless channel.

The memory 730 may store the control information or the data included in a signal obtained by the UE 700. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

FIG. 8 is a diagram illustrating a base station 800 according to an embodiment of the present disclosure.

Referring to the FIG. 8, the base station 800 may include a processor 810, a transceiver 820 and a memory 830. However, all of the illustrated components are not essential. The base station 800 may be implemented by more or less components than those illustrated in FIG. 8. In addition, the processor 810 and the transceiver 820 and the memory 830 may be implemented as a single chip according to another embodiment. The aforementioned components will now be described in detail.

The processor 810 may include one or more processors or other processing devices that control the proposed function, process, and/or method. Operation of the base station 800 may be implemented by the processor 810.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the base station 800. The memory 830 may be connected to the processor 810 and store at least one instruction or a protocol or a parameter for the proposed function, process, and/or method. The memory 830 may include read-only memory (ROM) and/or random access memory (RAM) and/or hard disk and/or CD-ROM and/or DVD and/or other storage devices.

Methods according to the claims of the disclosure or the various embodiments of the disclosure described in the specification may be implemented in hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs may include instructions that cause the electronic device to perform the methods in accordance with the claims of the disclosure or the various embodiments of the disclosure described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a Local Area Network (LAN), a wide area network (WAN), or a storage area network (SAN), or a combination thereof. The storage device may be connected to an apparatus performing the various embodiments of the disclosure through an external port. In addition, a separate storage device in the communication network may be connected to the apparatus performing the various embodiments of the disclosure.

In the various embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

1.-12. (canceled)

13. A method performed by a user equipment (UE) in a wireless communication system, the method comprising:
receiving, from a base station, system information associated with a number of subgroups for UE identity (ID) based subgrouping and a number of subgroups for a core network (CN) assigned subgrouping; and
determining a subgroup ID, based on the system information.

14. The method of claim 13, wherein the UE is in a cell supporting the UE ID based subgrouping.

15. The method of claim 13, further comprising:
receiving, from the base station, downlink control information (DCI) including bit information associated with paging early indication (PEI), wherein each bit in the bit information indicates one subgroup.

16. The method of claim 15, wherein a length of the bit information is determined based on a number of subgroups.

17. The method of claim 15, further comprising:
identifying that a corresponding bit for a subgroup of the UE in the bit information is set to 1.

18. The method of claim 17, further comprising:
monitoring a paging occasion (PO) for receiving a paging message, based on the identification.

19. A user equipment (UE) in a wireless communication system, the UE comprising:
a transceiver; and
at least one processor coupled with the transceiver and configured to:
receive, from a base station via the transceiver, system information associated with a number of subgroups for UE identity (ID) based subgrouping and a number of subgroups for a core network (CN) assigned subgrouping; and
determine a subgroup ID, based on the system information.

20. The UE of claim 19, wherein the UE is in a cell supporting the UE ID based subgrouping.

21. The UE of claim 19, wherein the at least one processor is further configured to:
receive, from the base station via the transceiver, downlink control information (DCI) including bit information associated with paging early indication (PEI), wherein each bit in the bit information indicates one subgroup.

22. The UE of claim 21, wherein a length of the bit information is determined based on a number of subgroups.

23. The UE of claim 21, wherein the at least one processor is further configured to:
identify that a corresponding bit for a subgroup of the UE in the bit information is set to 1.

24. The UE of claim 23, wherein the at least one processor is further configured to:
monitor a paging occasion (PO) for receiving a paging message, based on the identification.
